(19) United States
(12) Patent Application Publication
(10) Pub. No.: US 2024/0044672 A1
(43) Pub. Date: Feb. 8, 2024

(54) DETECTION MECHANISM

(71) Applicant: KABUSHIKI KAISHA TOKAI-RIKA-DENKI-SEISAKUSHO, Niwa-gun (JP)

(72) Inventors: Nobuaki MIYAKE, Aichi (JP); Hiroshi OHIRA, Aichi (JP); Yasumasa KONDO, Aichi (JP); Hiroshi TAKEOKA, Aichi (JP)

(21) Appl. No.: 18/363,261

(22) Filed: Aug. 1, 2023

(30) Foreign Application Priority Data
Aug. 5, 2022 (JP) 2022-125860

(51) Int. Cl. G01D 5/241; B62D 1/04

(52) U.S. Cl. CPC G01D 5/2417; B62D 1/046; B62D 1/06

(57) ABSTRACT

A detection mechanism includes: a detection unit that is provided on a contact body and detects contact with the contact body by a person; a conductive cloth provided in the detection unit, the conductive cloth being configured by weaving together two elements of a yarn to form an intersection point, the conductive cloth having conductivity; and a recess that is provided on an outer periphery of the conductive cloth and that severs the yarn.

### CROSS-REFERENCE TO RELATED APPLICATION

This application claims priority under 35 USC 119 from Japanese Patent Application No. 2022-125860 filed Aug. 5, 2022, the disclosure of which is incorporated by reference herein in its entirety.

### FIELD OF THE INVENTION

The present disclosure relates to a detection mechanism including a conductive cloth.

### RELATED ART

In an electrostatic capacitance sensor described in Japanese Patent Application Laid-Open (JP-A) No. 2021-82573, a detection electrode is configured by weaving warp and weft and forming intersections.

Here, in this electrostatic capacitance sensor, an angle between an outer periphery of the detection electrode and the warp and the weft is 45°, and the warp and the weft are cut at the outer periphery of the detection electrode (See paragraph [0081]).

### SUMMARY OF THE INVENTION

In view of the above fact, the present disclosure provides a detection mechanism capable of shortening a frayed length of a yarn of a conductive cloth even in a case where the yarn is frayed.

A detection mechanism according to a first aspect of the present disclosure includes: a detection unit that is provided at a contact body and detects contact with the contact body by a person; a conductive cloth provided in the detection unit, the conductive cloth being configured by weaving together two elements of a yarn to form an intersection point; and a recess that is provided on an outer periphery of the conductive cloth and that severs a yarn.

According to a detection mechanism of a second aspect of the present disclosure, in the detection mechanism of the first aspect of the present disclosure, the recess severs the yarn along the outer periphery of the conductive cloth.

According to a detection mechanism of a third aspect of the present disclosure, in the detection mechanism of the first aspect or the second aspect of the present disclosure, a plurality of recesses sever a same yarn.

According to a detection mechanism of a fourth aspect of the present disclosure, in the detection mechanism of the third aspect of the present disclosure, the plurality of recesses are continuously arranged along the outer periphery of the conductive cloth.

According to a detection mechanism of a fifth aspect of the present disclosure, in the detection mechanism of any one of the first to fourth aspects of the present disclosure, the recess severs the yarn forming a second intersection point inward from the outer periphery of the conductive cloth.

According to a detection mechanism of a sixth aspect of the present disclosure, in the detection mechanism of any one of the first to fifth aspects of the present disclosure, a distance from a second intersection point of the yarn, which forms a second intersection point inward from the outer periphery of the conductive cloth, to a severance position by the recess is smaller than a shortest distance from the second intersection point to an outer periphery of the detection unit.

According to a detection mechanism of a seventh aspect of the present disclosure, in the detection mechanism of any one of the first to sixth aspects of the present disclosure, the conductive cloth is provided on one side of the detection unit and a conductor is provided on an other side of the detection unit, and a distance from a second intersection point of the yarn, which forms a second intersection point inward from the outer periphery of the conductive cloth, to a severance position by the recess is smaller than a shortest distance from the second intersection point to the conductor passing through an outer periphery of the detection unit.

In the detection mechanism of the first aspect of the present disclosure, the detection unit of the contact body detects contact with the contact body by a person. Furthermore, in the detection unit, two elements of the yarn are woven to form the intersection point, thereby forming the conductive cloth, and the conductive cloth has conductivity.

Here, a recess is provided on the outer periphery of the conductive cloth, and the recess severs the yarn. Therefore, a length of the yarn inside the outer periphery of the conductive cloth can be shortened, and even in a case where the yarn of the conductive cloth is frayed, the frayed length of the yarn can be shortened.

In the detection mechanism of the second aspect of the present disclosure, the recess cuts the yarn along the outer periphery of the conductive cloth. For this reason, even in a case where the yarn runs along the outer periphery of the conductive cloth, the recess can cut the yarn, and the frayed length of the yarn can be shortened.

In the detection mechanism of the third aspect of the present disclosure, the plurality of recesses cut the same yarn. Therefore, the frayed length of the yarn can be effectively shortened.

In the detection mechanism of the fourth aspect of the present disclosure, the plurality of recesses are continuously arranged along the outer periphery of the conductive cloth. Therefore, an arrangement interval of the recesses can be reduced, and the frayed length of the yarn can be effectively shortened.

In the detection mechanism of the fifth aspect of the present disclosure, the recess severs the yarn forming the second intersection point inward from the outer periphery of the conductive cloth. Therefore, even in a case where the connection between the yarns at the first intersection point inward from the outer periphery of the conductive cloth is broken, the frayed length of the yarn forming the second intersection point inward from the outer periphery of the conductive cloth can be shortened.

In the detection mechanism of the sixth aspect of the present disclosure, the distance from the second intersection point of the yarn, which forms the second intersection point inward from the outer periphery of the conductive cloth, to the severance position by the recess is smaller than the shortest distance from the second intersection point to the outer periphery of the detection unit. Therefore, even in a case where the yarn forming the second intersection point inward from the outer periphery of the conductive cloth is frayed, the frayed length of the yarn can be made smaller than the shortest distance from the second intersection point to the outer periphery of the detection unit, and conduction of the yarn to a portion other than the conductive cloth can be suppressed.

In the detection mechanism of the seventh aspect of the present disclosure, the conductive cloth is provided on one side of the detection unit, and a conductor is provided on the other side of the detection unit. Furthermore, the distance from the second intersection point of a yarn forming the second intersection point inward from the outer periphery of the conductive cloth, to a severance position by the recess is smaller than a shortest distance from the second intersection point to the conductor passing through the outer periphery of the detection unit. Therefore, even in a case where the yarn forming the second intersection point inward from the outer periphery of the conductive cloth is frayed, the frayed length of the yarn can be made smaller than the shortest distance from the second intersection point to the conductor passing through the outer periphery of the detection unit, and conduction of the yarn to the conductor can be suppressed.

### BRIEF DESCRIPTION OF THE DRAWINGS

FIG. 1 is a front view illustrating a steering wheel according to an embodiment of the present disclosure as viewed from a front side.

FIG. 2A is a front view of a main part of the steering wheel according to the embodiment of the present disclosure as viewed from a front side.

FIG. 2B is a rear view of the main part of the steering wheel according to the embodiment of the present disclosure as viewed from a rear side.

FIG. 3 is an exploded perspective view illustrating the main part of the steering wheel according to the embodiment of the present disclosure as viewed from a front side.

FIG. 4 is a developed view illustrating a sensor of the steering wheel according to the embodiment of the present disclosure as viewed from a front side.

FIG. 5 is a developed view illustrating a sensor electrode of the steering wheel according to the embodiment of the present disclosure as viewed from a front side.

FIG. 6 is an enlarged developed view illustrating an intermediate portion of an inclined end of the sensor electrode in the steering wheel according to the embodiment of the present disclosure as viewed from a front side.

FIG. 7 is an enlarged developed view illustrating an end of an inclined end of the sensor electrode in the steering wheel according to the embodiment of the present disclosure as viewed from a front side.

### DESCRIPTION OF EXEMPLARY EMBODIMENTS

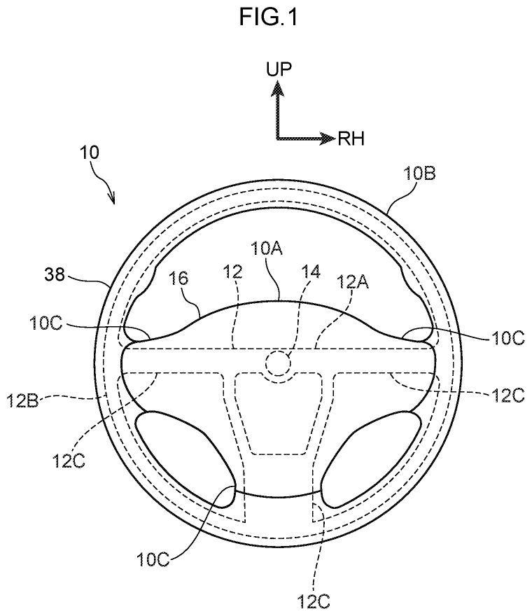

FIG. 1 is a front view of a steering wheel 10 as a contact body according to an embodiment of the present disclosure as viewed from a front side. Note that, in the drawings, a front side of the steering wheel 10 is indicated by an arrow FR, a right side of the steering wheel 10 is indicated by an arrow RH, and an upper side of the steering wheel 10 is indicated by an arrow UP.

The steering wheel 10 according to the present embodiment faces a driver's seat of a vehicle, and the steering wheel 10 is disposed on a vehicle front side of an occupant (driver, contact person) sitting in the driver's seat. Furthermore, the front side, the right side, and the upper side of the steering wheel 10 are directed to the rear side, the right side, and the upper side of the vehicle, respectively.

As illustrated in FIG. 1, a boss portion 10A as a fixing portion is provided in a central portion of the steering wheel 10, and a rim portion 10B as a contact portion having an annular shape in a front view is provided in an outer peripheral portion of the steering wheel 10. Between the boss portion 10A and the rim portion 10B, three spoke portions 10C as connection portions are provided, and the spoke portions 10C extend from the boss portion 10A to the left side, the right side, and the lower side to connect the boss portion 10A and the rim portion 10B.

The steering wheel 10 is provided with a core metal 12 as a frame member.

A plate-shaped boss core metal 12A is provided at a central portion of the core metal 12, and the boss core metal 12A constitutes the boss portion 10A. The boss core metal 12A is fixed to a vehicle rear side end (vehicle upper side end) of a columnar steering shaft 14 as a support shaft in the vehicle, and the steering shaft 14 is disposed coaxially with the rim portion 10B. The steering wheel 10 (core metal 12) is integrally rotatably supported by the steering shaft 14, and the occupant grips the rim portion 10B and rotates the steering wheel 10 in a circumferential direction, so that the steering shaft 14 is rotated about a center axis to steer the vehicle.

A rim core metal 12B having an annular shape in a front view is provided in an outer peripheral portion of the core metal 12, and the rim core metal 12B constitutes the rim portion 10B. Three long plate-shaped spoke core metals 12C are provided between the boss core metal 12A and the rim core metal 12B, and the spoke core metals 12C extends from the boss core metal 12A to the left side, the right side, and the lower side (radially outside the steering wheel 10) to integrally connect the boss core metal 12A and the rim core metal 12B and constitute the spoke portions 10C.

The boss portion 10A and the spoke portions 10C are provided with a plate-like pad 16 as a covering member, and the pad 16 is attached to the front side of the boss core metal 12A and the spoke core metals 12C to cover the front side of the boss core metal 12A and the spoke core metals 12C.

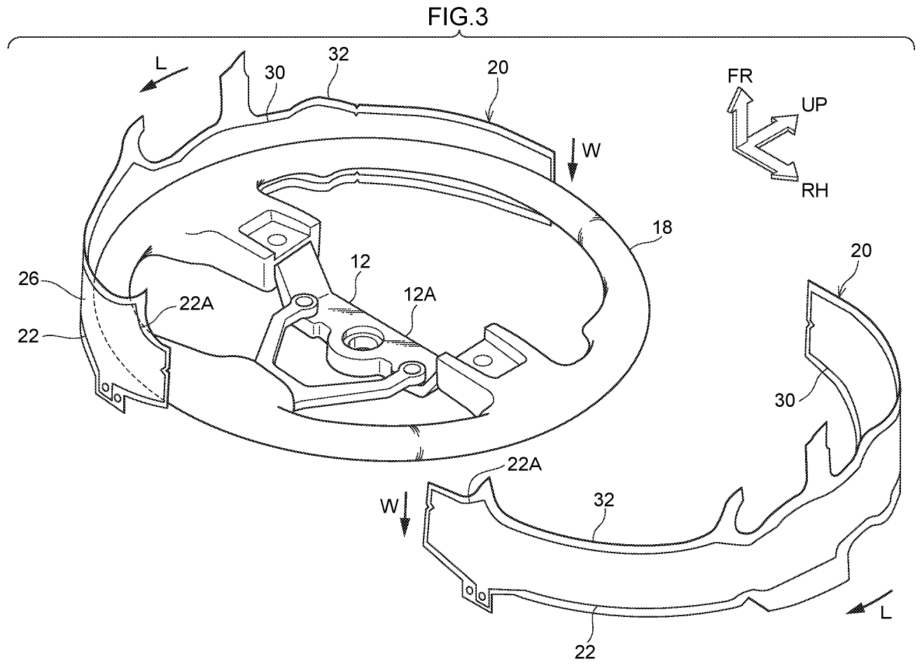

An inner member 18 (See FIG. 3) having an annular shape in a front view as an installation member is provided on the entire rim portion 10B in a longitudinal direction (circumferential direction of the steering wheel 10) and the circumferential direction (direction around the longitudinal direction). The inner member 18 is made of a soft resin (for example, made of polyurethane), and has a circular outer shape in a cross section perpendicular to the longitudinal direction. The rim core metal 12B is accommodated in the inner member 18, and the inner member 18 is fixed to the rim core metal 12B.

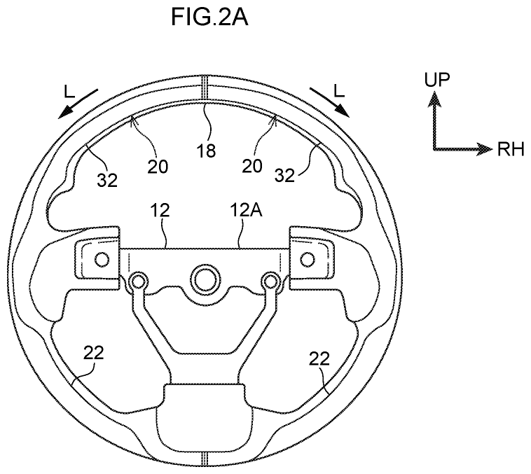

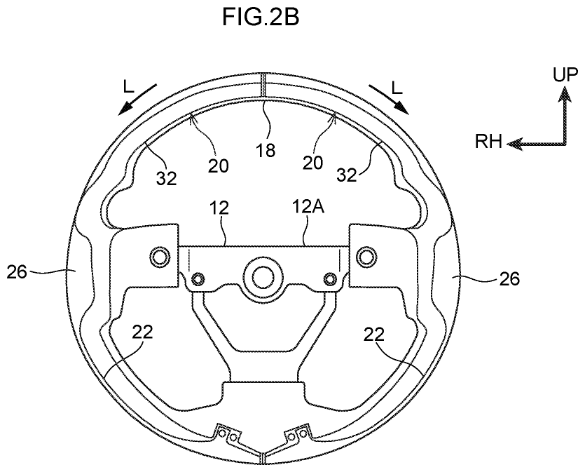

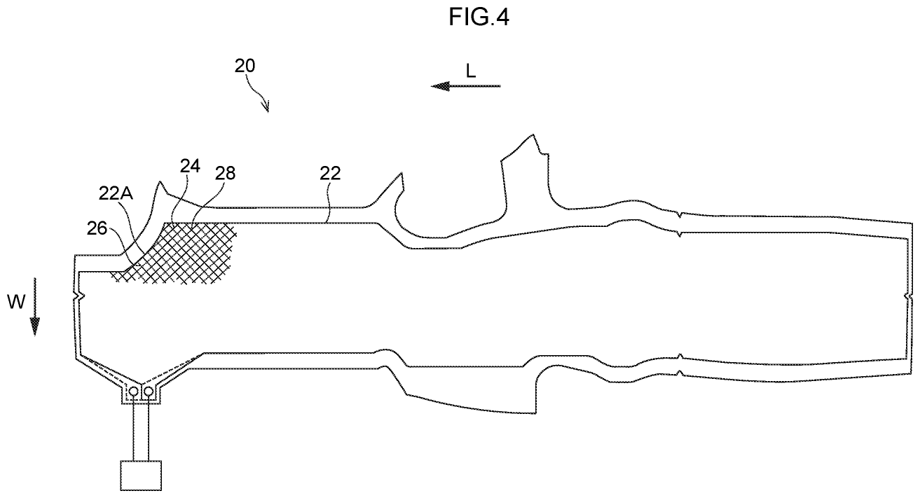

A substantially long rectangular sheet-shaped sensor 20 (See FIGS. 2A, 2B, 3, and 4) as a detection unit constituting a detection mechanism is provided in each of a left side portion and a right side portion of the rim portion 10B, and the sensor 20 is wound and attached around an outer periphery of the inner member 18. A longitudinal direction of the sensor 20 is disposed to be curved along the longitudinal direction of the rim portion 10B, and one side in the longitudinal direction of the sensor 20 (direction of arrow L in FIG. 4) is directed to the lower side in the longitudinal direction of the rim portion 10B. A width direction of the sensor 20 is curved and disposed along the circumferential direction of the rim portion 10B, and one side in the width direction (direction of arrow W in FIG. 4) of the sensor 20 is directed to the rear side in the circumferential direction of the rim portion 10B. A center of the sensor 20 in the width direction is disposed on an outer side of the rim portion 10B in a radial direction of the steering wheel 10, and both ends of the sensor 20 in the width direction are disposed on an inner side of the rim portion 10B in the radial direction of the steering wheel 10.

A substantially long rectangular cloth-like sensor electrode 22 as a conductive cloth (sensor unit) is provided in a front side portion of the sensor 20 (a radially outer portion of the rim portion 10B), and one side in the longitudinal direction and one side in the width direction of the sensor electrode 22 are directed to one side in the longitudinal direction and one side in the width direction of the sensor 20, respectively.

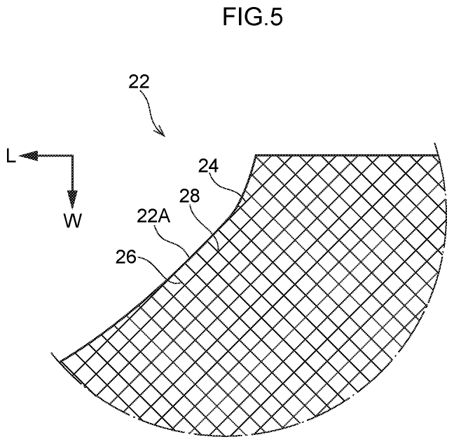

The sensor electrode 22 is formed by weaving a first yarn 24 (one of warp and weft) and a second yarn 26 (the other of warp and weft) as yarns to form an intersection point 28 (intersecting portion) (See FIGS. 4 and 5). In FIGS. 4 and 5, an outline of the first yarn 24 and the second yarn 26 in a part of the sensor electrode 22 is illustrated, and an arrangement interval of the first yarn 24 and an arrangement interval of the second yarn 26 are illustrated to be larger than an actual arrangement interval. The sensor electrode 22 has conductivity with metal plating formed on the entire outer periphery in a state where the first yarn 24 and the second yarn 26 are woven, and the first yarn 24 and the second yarn 26 are connected by metal plating at the intersection point 28 and are conducted. The first yarn 24 is inclined in a direction toward one side in the width direction of the sensor electrode 22 as it goes toward one side in the longitudinal direction of the sensor electrode 22, the second yarn 26 is inclined in a direction toward one side in the width direction of the sensor electrode 22 as it goes toward the other side in the longitudinal direction of the sensor electrode 22, and the first yarn 24 and the second yarn 26 are inclined by 45° with respect to the longitudinal direction and the width direction of the sensor electrode 22. The sensor electrode 22 is not extendable in an extending direction of the first yarn 24 and an extending direction of the second yarn 26, and is extendable in a direction different from the extending direction of the first yarn 24 and the extending direction of the second yarn 26. The sensor electrode 22 is extendable in the longitudinal direction and the width direction.

A linear inclined end 22A is formed on an outer periphery on the other side in the width direction of one side portion in the longitudinal direction of the sensor electrode 22. The inclined end 22A is inclined in a direction toward one side in the width direction of the sensor electrode 22 as it goes toward one side in the longitudinal direction of the sensor electrode 22. The inclined end 22A is inclined by 45° with respect to the longitudinal direction and the width direction of the sensor electrode 22, and the first yarn 24 is disposed along the inclined end 22A on an inner side of the sensor electrode 22 at the inclined end 22A. Furthermore, the outer periphery of the sensor electrode 22 protrudes to the outside of the sensor electrode 22 on both outer sides of the inclined end 22A.

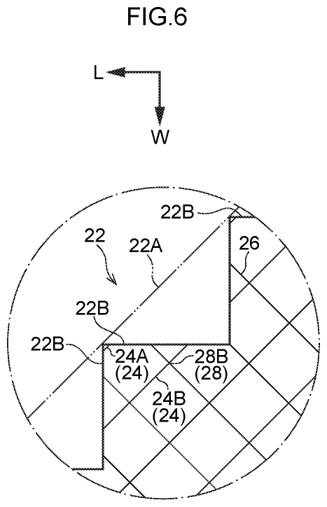

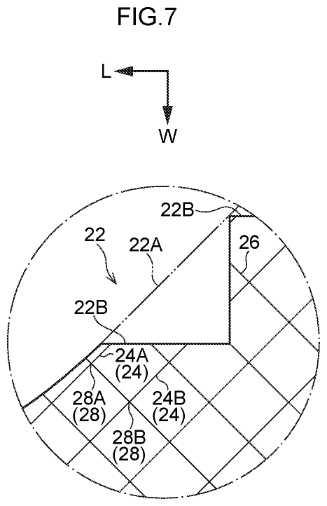

A plurality of triangular recesses 22B (See FIGS. 6 and 7) are formed in the inclined end 22A, and end sides of the plurality of recesses 22B are parallel to the longitudinal direction and the width direction of the sensor electrode 22, and are continuously arranged along the inclined end 22A in the entire inclined end 22A. First and second first yarns 24 (hereinafter, the first first yarn 24 is referred to as a “first yarn 24A”, and the second first yarn 24 is referred to as a “first yarn 24B”) inward from the inclined end 22A of the sensor electrode 22 (including an open end of each of the recesses 22B) are severed by the recess 22B. Furthermore, on an inner side of the inclined end 22A of the sensor electrode 22, substantially all the intersection points 28 (hereinafter referred to as “intersection points 28A”) of the first first yarn 24A and the second yarn 26 are severed, and the intersection points 28 (hereinafter referred to as “intersection points 28B”) of the second first yarn 24B and the second yarn 26 are partially severed and partially remain. Furthermore, the first first yarn 24A inward from the inclined end 22A of the sensor electrode 22 forms the first intersection point 28A along the second yarn 26 inward from the outer periphery of the sensor electrode 22 at least on both outer sides of the inclined end 22A, and the second first yarn 24B inward from the inclined end 22A of the sensor electrode 22 forms the second intersection point 28B along the second yarn 26 inward from the outer periphery of the sensor electrode 22 at least on both outer sides of the inclined end 22A.

A substantially long rectangular cloth-like shield electrode 30 as a conductor (shield portion) is provided on a back side portion of the sensor 20 (a radially inner portion of the rim portion 10B). The shield electrode 30 has substantially the same configuration as the sensor electrode 22, but the recess 22B is not formed.

An insulator 32 having a substantially long rectangular sheet shape as an insulating portion is provided between the sensor electrode 22 and the shield electrode 30, and one side in the longitudinal direction and one side in the width direction of the insulator 32 are directed to one side in the longitudinal direction and one side in the width direction of the sensor 20, respectively. The sensor electrode 22 and the shield electrode 30 are fixed to the insulator 32, and an outer periphery of the insulator 32 is disposed outside an outer periphery of the sensor electrode 22 and an outer periphery of the shield electrode 30. The insulator 32 is made of resin, and the insulator 32 electrically insulates the sensor electrode 22 from the shield electrode 30.

Each of the sensor electrode 22 and the shield electrode 30 is electrically connected to a control device 36 (ECU) of the vehicle at a portion on one side in the longitudinal direction and one side in the width direction.

A leather 38 as an outer peripheral member constituting a detection mechanism is provided on the entire outer periphery of the rim portion 10B. The leather 38 covers the sensor 20 and constitutes a front surface (radially outer surface) of the rim portion 10B.

Next, an operation of the present embodiment will be described.

In the steering wheel 10 having the above configuration, when the occupant grips the rim portion 10B and the occupant's hand comes into contact with the front surface of the leather 38 of the rim portion 10B, the control device 36 detects an electrostatic capacitance generated between the occupant's hand and the sensor electrode 22 of the sensor 20, and detects the grip of the rim portion 10B of the occupant (the contact of the hand with the leather 38). Furthermore, the sensor electrode 22 and the shield electrode 30 of the sensor 20 are controlled to the same potential by the control device 36. As a result, the generation of parasitic capacitance between the sensor electrode 22 and the rim core metal 12B is limited by the shield electrode 30. Therefore, the electrostatic capacitance generated between the hand of the occupant and the sensor electrode 22 is suppressed from changing due to the parasitic capacitance, and the detection accuracy of gripping of the rim portion 10B of the occupant is suppressed from deteriorating.

By the way, in the rim portion 10B, for example, when the sensor 20 is wound around the outer periphery of the inner member 18 and assembled, a frictional force to the outer peripheral outside is applied to the sensor electrode 22, so that the connection of the first intersection point 28 (connection of the first yarn 24 and the second yarn 26) along the first yarn 24 or the second yarn 26 is easily broken from the outer periphery to the inner side of the sensor electrode 22. Furthermore, at the inclined end 22A of the sensor electrode 22, the connection of the first intersection point 28 along the first yarn 24 or the second yarn 26 from the recess 22B to the inside of the sensor electrode 22 is also easily broken. Therefore, the first yarn 24 and the second yarn 26 forming the respective intersection points 28 are easily frayed.

Here, the recess 22B is provided at the inclined end 22A of the sensor electrode 22, and the recess 22B severs the first yarns 24A and 24B. Therefore, lengths of the first yarns 24A and 24B on the inner side of the sensor electrode 22 at the inclined end 22A can be shortened. Thus, even in a case where the first yarns 24A and 24B are frayed, the frayed lengths of the first yarns 24A and 24B can be shortened, and the first yarns 24A and 24B can be prevented from electrically connecting the sensor electrode 22 and a portion other than the sensor electrode 22.

Furthermore, the recess 22B severs the first yarns 24A and 24B along the inclined end 22A of the sensor electrode 22. Therefore, even in a case where the first yarns 24A and 24B are along the inclined end 22A, the recess 22B can sever the first yarns 24A and 24B, and the frayed lengths of the first yarns 24A and 24B can be shortened.

Moreover, the same first yarns 24A and 24B along the inclined end 22A of the sensor electrode 22 are severed by a plurality of the recesses 22B. Therefore, the frayed lengths of the first yarns 24A and 24B can be effectively shortened.

In addition, the plurality of recesses 22B are continuously arranged along the inclined end 22A of the sensor electrode 22. Therefore, an arrangement interval of the recesses 22B can be reduced, and the frayed lengths of the first yarns 24A and 24B can be effectively shortened.

Furthermore, the recess 22B severs the first yarn 24B forming the second intersection point 28B along the second yarn 26 from the outer periphery of the sensor electrode 22 to the inner side on both outer sides of the inclined end 22A. Therefore, even in a case where the connection of the first intersection point 28A along the second yarn 26 is broken from the outer periphery to the inner side of the sensor electrode 22 on both outer sides of the inclined end 22A, the frayed length (extended length starting from the intersection point 28B) of the first yarn 24B forming the second intersection point 28B (second intersection point 28B from the outermost recess 22B along the first yarn 24B) along the second yarn 26 from the outer periphery of the sensor electrode 22 to the inner side on both outer sides of the inclined end 22A can be shortened.

Moreover, a distance from the intersection point 28B of the first yarn 24B forming the second intersection point 28B (second intersection point 28B from the outermost recess 22B along the first yarn 24B) from the outer periphery of the sensor electrode 22 to the inner side along the second yarn 26 on both outer sides of the inclined end 22A to the severance position by the recess 22B is made smaller than the shortest distance from the intersection point 28B to the outer periphery of the sensor 20 (outer periphery of the insulator 32). Therefore, even in a case where the first yarn 24B forming the intersection point 28B is frayed, the frayed length of the first yarn 24B (the extended length starting from the intersection point 28B) can be made smaller than the shortest distance from the intersection point 28B to the outer periphery of the sensor 20. Accordingly, the first yarn 24B can be suppressed from being electrically connected to the portion other than the sensor electrode 22, and the sensor electrode 22 can be suppressed from being electrically connected to the portion other than the sensor electrode 22 through the first yarn 24B.

Moreover, the distance from the intersection point 28B of the first yarn 24B forming the second intersection point 28B (second intersection point 28B from the outermost recess 22B along the first yarn 24B) from the outer periphery of the sensor electrode 22 to the inner side along the second yarn 26 on both outer sides of the inclined end 22A to the severance position by the recess 22B is made smaller than the shortest distance from the intersection point 28B to the shield electrode 30 passing through the outer periphery (outer periphery of the insulator 32) of the sensor 20. Therefore, even in a case where the first yarn 24B forming the intersection point 28B is frayed, the frayed length of the first yarn 24B (the extended length starting from the intersection point 28B) can be made smaller than the shortest distance from the intersection point 28B to the shield electrode 30 passing through the outer periphery of the sensor 20. Accordingly, the conduction of the first yarn 24B to the shield electrode 30 can be suppressed, and the conduction of the sensor electrode 22 to the shield electrode 30 through the first yarn 24B can be suppressed.

Note that, in the present embodiment, the plurality of recesses 22B are continuously provided in the inclined end 22A of the sensor electrode 22. However, the plurality of recesses 22B may be provided at intervals in the inclined end 22A of the sensor electrode 22.

Furthermore, in the present embodiment, the plurality of recesses 22B are provided at the inclined end 22A of the sensor electrode 22. However, the number of recesses 22B provided at the inclined end 22A of the sensor electrode 22 may be plural or one.

Moreover, in the present embodiment, the recesses 22B are provided at the inclined end 22A of the sensor electrode 22. However, the recesses 22B may be provided on the outer periphery of the sensor electrode 22 other than the inclined end 22A.

Furthermore, in the present embodiment, the recesses 22B are provided on the outer periphery of the sensor electrode 22. However, the recesses 22B may be provided on the outer periphery of the shield electrode 30 (conductive cloth).

Moreover, in the present embodiment, the sensor electrode 22, the shield electrode 30, and the insulator 32 are provided in the sensor 20. However, the sensor electrode 22 may be provided in the sensor 20, and the shield electrode 30 and the insulator 32 may not be provided in the sensor.

Furthermore, in the present embodiment, the sensor 20 is provided on the steering wheel 10 (contact body). However, the sensor 20 may be provided on a contact body (for example, a seat of the vehicle) other than the steering wheel 10.

What is claimed is:

1. A detection mechanism, comprising:
a detection unit that is provided at a contact body and detects contact with the contact body by a person;
a conductive cloth provided in the detection unit, the conductive cloth being configured by weaving together two elements of a yarn to form an intersection point; and
a recess that is provided on an outer periphery of the conductive cloth and that severs the yarn.

2. The detection mechanism according to claim 1, wherein the recess severs the yarn along the outer periphery of the conductive cloth.

3. The detection mechanism according to claim 1, wherein a plurality of recesses sever a same yarn.

4. The detection mechanism according to claim 3, wherein the plurality of recesses are continuously arranged along the outer periphery of the conductive cloth.

5. The detection mechanism according to claim 1, wherein the recess severs the yarn forming a second intersection point inward from the outer periphery of the conductive cloth.

6. The detection mechanism according to claim 1, wherein a distance from a second intersection point of the yarn, which forms a second intersection point inward from the outer periphery of the conductive cloth, to a severance position by the recess is smaller than a shortest distance from the second intersection point to an outer periphery of the detection unit.

7. The detection mechanism according to claim 1, wherein the conductive cloth is provided on one side of the detection unit and a conductor is provided on another side of the detection unit, and a distance from a second intersection point of the yarn, which forms a second intersection point inward from the outer periphery of the conductive cloth, to a severance position by the recess is smaller than a shortest distance from the second intersection point to the conductor passing through an outer periphery of the detection unit.

8. The detection mechanism according to claim 1, wherein:
the contact body includes a steering wheel of a vehicle, and
the detection unit includes a sensor provided at the steering wheel.
